(19) United States
(12) Patent Application Publication
(10) Pub. No.: US 2014/0362098 A1
(43) Pub. Date: Dec. 11, 2014

(54) DISPLAY STREAM COMPRESSION

(71) Applicant: Sharp Laboratories of America, Inc., Camas, WA (US)

(72) Inventor: Louis J. Kerofsky, Camas, WA (US)

(21) Appl. No.: 13/914,314

(22) Filed: Jun. 10, 2013

(51) Int. Cl. G06T 1/60

(52) U.S. Cl. CPC G06T 1/60
USPC 345/547

(57) ABSTRACT

A method for video coding is described. A compressed bitstream is received from a host via a data link. Each slice of the compressed bitstream is mapped to a compressed frame buffer. The compressed frame buffer supports selective overwriting for regional updates. Parallel processing of the compressed data in the compressed frame buffer is performed. Pixel data is written to a display panel.

### TECHNICAL FIELD

The present disclosure relates generally to electronic devices. More specifically, the present disclosure relates to systems and methods for display stream compression (DSC).

### BACKGROUND

Electronic devices have become smaller and more powerful in order to meet consumer needs and to improve portability and convenience. Consumers have become dependent upon electronic devices and have come to expect increased functionality. Some examples of electronic devices include desktop computers, laptop computers, cellular phones, smart phones, media players, integrated circuits, etc.

Many electronic devices include a display for presenting information to consumers. For example, portable electronic devices include displays for allowing digital media to be consumed at almost any location where a consumer may be. For instance a consumer may use an electronic device with a display to check email, view pictures, watch videos, see social network updates, etc. In many cases, larger displays enhance usability and enjoyment for consumers.

However, the power requirements of a display may be problematic. For portable electronic devices, the power requirement of a display may significantly limit the battery life. The increasing demand for reducing power consumption while providing the same viewing experience for the consumer may be problematic. As can be observed from this discussion, systems and methods for reducing the power consumption of a display may be beneficial.

### BRIEF DESCRIPTION OF THE DRAWINGS

FIG. 1 is a block diagram illustrating an example of an electronic device in which systems and methods for adapting display behavior may be implemented;

FIG. 2 is a block diagram illustrating a host and a display module for use in the present systems and methods;

FIG. 3 is a flow diagram of a method for display stream compression (DSC);

FIG. 4 is a block diagram illustrating a frame that includes multiple slices;

FIG. 5 is a block diagram illustrating partial width slices;

FIG. 6 is a block diagram illustrating a selective update decoder for use in the present systems and methods;

FIG. 7 is a block diagram illustrating serial slice decoding;

FIG. 8 is a block diagram illustrating round robin slice decoding;

FIG. 9 is a block diagram illustrating parallel slice decoding within a row; and

FIG. 10 illustrates various components that may be utilized in an electronic device.

### DETAILED DESCRIPTION

A method for video coding is described. A compressed bitstream is received from a host via a data link. Each slice of the compressed bitstream is mapped to a compressed frame buffer. The compressed frame buffer supports selective overwriting for regional updates. Parallel processing of the compressed data is performed in the compressed frame buffer. Pixel data is written to a display panel.

Slice data may be interleaved for transmission. Slice data may be provided to each decoder without buffering compressed data. The transmission of compressed data may use scheduling to avoid collisions between mapping slices to the compressed frame buffer and decoding slices from the compressed frame buffer. A decoder may begin decoding a frame from the compressed frame buffer after an offset from the beginning of a frame time. The decoder may operate on slices in raster scan at a uniform rate until the end of the frame.

The method may be performed by a mobile device. In one configuration, the method may be performed by a display stream compression decoder on the mobile device. The compressed frame buffer may be linear. A compressed slice location list may be maintained for the compressed frame buffer. The compressed slice location list may include a start time for each slice, an end time for each slice and a location of the slice within the compressed frame buffer.

Regional updates may be implemented when a limited number of full slices of compressed data are received. Regional updates may include the location of a slice, a size of the slice and where the slice is located in the compressed frame buffer. The compressed frame buffer may include reserved space for each slice based on slice geometry and a maximum size of each slice. The content and transmission of the compressed bitstream may be constrained by multiple hypothetical reference decoders (HRDs). The arrival of bits in an ith HRD may be delayed by

$$i \frac{R}{M}$$

bits relative to the arrival of bits in a 0th HRD. R may be a bit rate and M may be a number of HRDs. Bits may arrive at an HRD at a uniform rate of R/M bits per pixel time P. For example the constraint may be that none of the parallel HRDs overflow or underflow.

An electronic device is also described. The electronic device includes a compressed buffer that supports selective overwriting for regional updates. The electronic device also includes a slice mapper that maps a compressed bitstream to the compressed buffer. The electronic device further includes one or more decoders that perform parallel processing of compressed data from the compressed buffer. The electronic device also includes a display panel that displays decoded data.

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

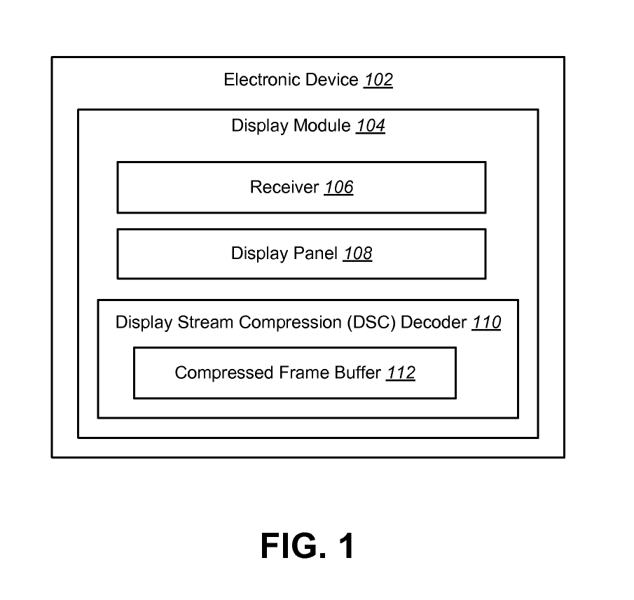

FIG. 1 is a block diagram illustrating an example of an electronic device 102 in which mobile display stream compression (DSC) may be implemented. Display stream compression (DSC) refers to a standard administered by the Video Electronics Standards Association (VESA) that enables increased display resolutions over existing interfaces with optimized power consumption. However, the current design of the display stream compression (DSC) standard has not focused on the details of the power savings application. One significant challenge within the display stream compression (DSC) framework is enabling regional updates with a compressed frame buffer 112. The systems and methods disclosed herein provide for the use of regional updates and a compressed frame buffer 112 within the display stream compression (DSC) framework.

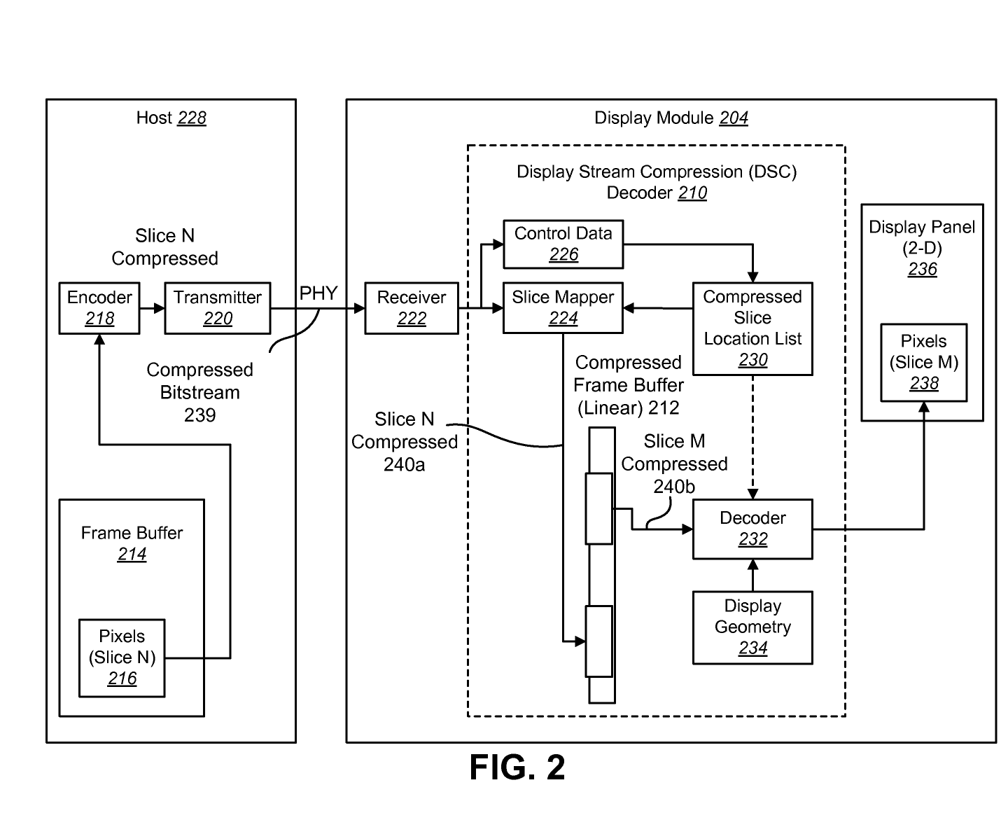

The electronic device 102 may be a user equipment (UE), a mobile station, a subscriber station, an access terminal, a remote station, a user terminal, a terminal, a handset, a subscriber unit, a wireless communication device, a laptop, a portable video game unit, etc. The electronic device 102 may include a display module 104. The display module 104 may allow the electronic device 102 to display high quality video to a user (i.e., via a display panel 108) with reduced power consumption. For example, the display module 104 may include mobile display panels 108 where battery life is critical. The display module 104 may support compression over the display link layer and within a compressed frame buffer 112 in the display module 104 by including a display stream compression (DSC) decoder 110. The display stream compression (DSC) decoder 110 is discussed in additional detail below in relation to FIG. 2. The display module 104 may also include a receiver 106.

The embedded Display Port (eDP) 1.4 standard defines some tools for saving power. These tools include panel self refresh (PSR), link level compression and self refresh with selective update (PSR2). Panel self refresh (PSR) allows a host graphics unit to enter a low power state when the display content is unchanging. The display module 104 may refresh the display on the display panel 108 based on a local frame memory. However, panel self refresh (PSR) needs a frame memory within the display module 104 to operate.

Link level compression applies compression to the video data transmitted across the data link, allowing the data link to run at a lower rate (thereby saving power). Link level compression may use simple codecs. The compression algorithm may be a relatively simplistic operation performed on samples without a spatial transform. However, the lack of guarantees on the compression ratio necessitates that the decoder have an uncompressed frame buffer to support selective regional updates.

Regional updates may work in conjunction with a frame buffer, allowing the display source to send data for the regions of the display that have changed, while relying on the data in the frame buffer for areas which have not changed. Regional updates may be particularly effective when most of an image is constant (e.g., editing a document on a computer). In eDP 1.3, regional updates (also referred to as selective updates) are described by a set of scan lines and X position within the scan lines. The X position may be required to be a multiple of 16. Selective regional updates may include compression but the compressed data must be decompressed prior to storage in a frame buffer.

In eDP 1.4, the display module 104 may require either an uncompressed frame buffer or compression/transcoding. The display module 104 may also require two lines of uncompressed memory for the bitstream buffer (although the display module 104 may be able to implement this requirement with less memory). Furthermore, the display module in eDP 1.4 may require that the source encoder have tight buffer management when using compressed data.

The use of compression in the frame buffer of a display (i.e., the compressed frame buffer 112) may reduce the size/cost of the frame buffer as well as reduce the power consumption of the electronic device 102. The use of a reduced display refresh when the native display panel has a hold characteristic (such as recent indium gallium zinc oxide (IGZO) panels) may also result in power savings for the electronic device 102.

A display stream compression (DSC) decoder 110 that includes a compressed frame buffer 112 and that is capable of using regional updates may include additional restrictions. For the bitstream structure, the stream must be divisible into independently decodable unites (referred to as slices) to enable the replacement of regions in future frames. The slice structure may only change on full frame updates. A compressed slice may be required to be less than a bound established when a full frame was coded to avoid overwriting other slices. In addition, each slice must be identifiable within a code stream either by marker codes or at known positions (i.e., a fixed slice size). This is because the display stream compression (DSC) decoder 110 needs to know where to place regional updates in the compressed frame buffer 112 and the display stream compression (DSC) decoder 110 needs to know the end of each slice (either by the given size or by the marker codes).

The scheduling of regional updates needs to be controlled to avoid damaging data being decoded by updates to the code stream. In one configuration, the schedule of possible times to transmit regional updates may be based on the first/last line of the update. Regional updates may also be required to signal the region of the update, thereby allowing the display stream compression (DSC) decoder 110 to determine the slice addresses from the regional update. Existing methods describe the region of the update in a regional update using pixel coordinates, which may not be practicable. The frame may be padded to an integer number of slices (height and width) or the frame may allow smaller slices (i.e., partial width slices). The regional update syntax needs to be compatible with existing eDP handling of regional updates.

The use of display stream compression (DSC) may provide power and cost savings for mobile devices while enabling higher resolution throughput. There are two types of display stream compression (DSC) under consideration: high throughput and reduced power. For high throughput, it is anticipated that display stream compression (DSC) will support high resolution displays over limited display links. Both visual quality and compression efficiency are key elements of high throughput display stream compression (DSC). Complexity is important, since memory for the code stream buffer is less than both the line and the clock rate needed to provide the pixel output rate. The high throughput application includes block to raster conversions that may be too complex. Furthermore, the high throughput application ignores the error rate assumed to be addressed by the transport layer forward error correction (FEC). The high throughput application has an initial target of 12 bits per pixel (bpp) based on the projected link rates.

For the reduced power application, link layer compression may be used to reduce the data rate (and hence reduce the power consumption). The reduced power applications support existing power saving tools such as panel self refresh (PSR) and regional updates of embedded Display Port (eDP) 1.4. The reduced power application may support frame buffer compression with an algorithm common to link layer compression to avoid the cost of transcoding. Reduced power applications have a target bit per pixel (bpp) of 8. A fixed compressed slice size may be needed to support panel self refresh (PSR) and the compressed frame buffer 112.

FIG. 2 is a block diagram illustrating a host 228 and a display module 204 for use in the present systems and methods. In one configuration, the host 228 may be located on the same electronic device 102 as the display module 204. In another configuration, the host 228 may be located on a first electronic device 102 and the display module 204 may be located on a second electronic device 102. The host 228 may provide a compressed bitstream 239 to the display module 204 for display on a display panel 236 (two-dimensional) of the display module 204. For example, the host 228 may provide a video stream for viewing on the display panel 236.

The host 228 may include a frame buffer 214. The frame buffer 214 may include a group of pixels 216 (referred to as slice N) that is to be provided to the display module 204. In one configuration, the slice N may be a regional update. The frame buffer 214 provides each slice to an encoder 218. The encoder 218 outputs a compressed slice (e.g., slice N compressed) to a transmitter 220. The transmitter 220 then provides the compressed slice to the display module via a data link (referred to as the physical layer (PHY)). The transmitter 220 is thus providing a continuous stream of data (i.e., a compressed bitstream 239) to the display module 204 with a maximum number of bits per pixel (MaxLinkBitsPerPixel). For selective regional updates, the data flow may be suspended (thus, the compressed bitstream 239 may not be continuous). The compressed bitstream 239 may be divided into independently decodable slices. The use of display stream compression (DSC) may enable higher resolution over limited display links such as Display Port, HDMI and USB 3.0.

The display module 204 receives the compressed bitstream 239 using a receiver 222. The receiver 222 then provides the received compressed bitstream 239 to a display stream compression (DSC) decoder 210. The display stream compression (DSC) decoder 210 may include a slice mapper 224, control data 226, a compressed frame buffer 212, a decoder 232 and display geometry 234. The display stream compression (DSC) decoder 210 may map slices of regional updates in the compressed frame buffer 212 (also referred to as a compressed bitstream buffer). The slice mapper 224 may determine where slices 240a are placed in the compressed frame buffer 224 (i.e., the compressed slice location stored in a compressed slice location list 230), which is determined from control data 226 obtained from the received compressed bitstream 239. Because the compressed data may be interleaved, the slice mapper 224 may need to deinterleaves the compressed data before placing slices 240a in the compressed frame buffer 224.

The size of compressed slices 240a may be bounded by a limit (which implies the necessary size of the compressed frame buffer 239). In addition, the encoder 218 must ensure that unchanged slices in the compressed frame buffer 212 are not overwritten. Thus, untransmitted slices 240 will not be overwritten in the frame buffer 214. Furthermore, the transmission of regional updates should be restricted to avoid collisions between the slice mapper 224 and the decoder 232 each accessing the compressed frame buffer 212 at the same time. This is not a significant issue with an uncompressed frame buffer but can be problematic with a compressed frame buffer 212.

The compressed bitstream 239 may be a compressed representation of pixels 216 for display. The compressed bitstream 239 for each frame may be decomposed into independently decodable units (slices 240). Each slice 240 may include an identifier based on the position in raster scan order. The code stream structure may have the ability to start and end each slice 240 within the code stream. In one configuration, this may require a fixed number of bits per slice 240. In another configuration, the slice 240 size may be signaled as part of an update. Markers in the code stream may also be used at slice 240 boundaries. In one configuration, single slices 240 per update may be used, making the start of each slice 240 determined by the update command from the host 228.

Each slice 240 may be bounded based on the number of bits per pixel (bpp) placed on the compressed frame buffer 212 as given in Equation (1):

∀nSize(Slice[n])≦NumberPixelsPerSlice·MaxBufferBitsPerPixel. (1)

The total data from all slices 240 for each frame may be limited based on a bound on the number of bits per pixel placed on the link rate between the transmitter 220 and the receiver 222 (in addition to the limits on the individual slice 240 size) as described in Equation (2):

ΣSize(Slice[n])≦NumberPixelsPerFrame·MaxLinkBitsPerPixel. (2)

The display stream compression (DSC) decoder 210 may maintain a compressed slice location list 230. The compressed slice location list 230 allows the slice mapper 224 and the decoder 232 to determine the location (i.e., the starting point and ending point) of each slice 240 in the compressed frame buffer 212. The slice 240 geometry determines the number of pixels per slice 240. A bound on the slice 240 size MaxSliceSize may be set by the number of pixels in the slice 240 and the parameter MaxBufferBitsPerPixel as given in Equation (3):

MaxSliceSize=NumberPixelsPerSlice·MaxBufferBitsPerPixel. (3)

The compressed frame buffer 212 may allocate this amount of space (i.e., the MaxSliceSize) for the slice 240 and any future regional updates of the slice 240. The start of each slice 240 in the compressed frame buffer 212 is determined by the number of pixels in each slice 240 and the bound on bits per pixel (bpp) in a slice 240: SliceStart[n]=n·MaxSliceSize. The slice 240 start may typically be rounded up to the nearest byte boundary in implementations. The end of each slice 240 in the compressed frame buffer 212 is determined by the start and by the number of compressed bits used to represent the slice 240: slice_{—bits[n].}

The slice mapper 224 is responsible for receiving a code stream in a full frame or regional updates and mapping the code stream to the compressed frame buffer 212. The slice mapper 224 may read the slice number from the compressed bitstream 239 or regional update and determine where the data should be placed in the compressed frame buffer 239 (and how much data to write). The slice number may be inferred by tracking the amount of data received since the beginning of a frame rather than signaled explicitly. In one configuration, the compressed data for slices 240 may be interleaved during transmission. The interleaving may include interleaving data from the slices 240 in each row. Interleaving may be performed at the bit/byte level.

The slice mapper 224 may also update the compressed slice location list 230. For example, the slice mapper 224 may update the compressed slice location list 230 with the actual size in bits of each compressed slice 240. The compressed slice location list 230 may indicate whether slice 240 sizes are fixed, the starting point of a slice 240 and the ending point of a slice 240 within the compressed frame buffer 212. The slice mapper 224 may copy the compressed data for each slice 240 received from the physical layer (PHY) into the compressed frame buffer 212. The slice mapper 224 may also introduce data alignment or structure onto the data written to the compressed frame buffer 212.

The compressed frame buffer 212 may hold the code stream for each slice 240 of the frame. Space may be reserved for each slice 240 based on the slice 240 geometry and the maximum size of each slice 240 according to Equation (3) above. The data in the compressed frame buffer 212 may be accessed in an interleaved/parallel fashion. The data may be interleaved during transmission. A slice 240 row time interleaved data transmission refers to scenarios where data from each slice 240 in a row is interleaved at slice 240 row time intervals. For bit/byte interleaved slice 240 data, no additional buffering is needed for the compressed data. Individual slice 240 columns may be delayed relative to each other to further reduce buffering needs.

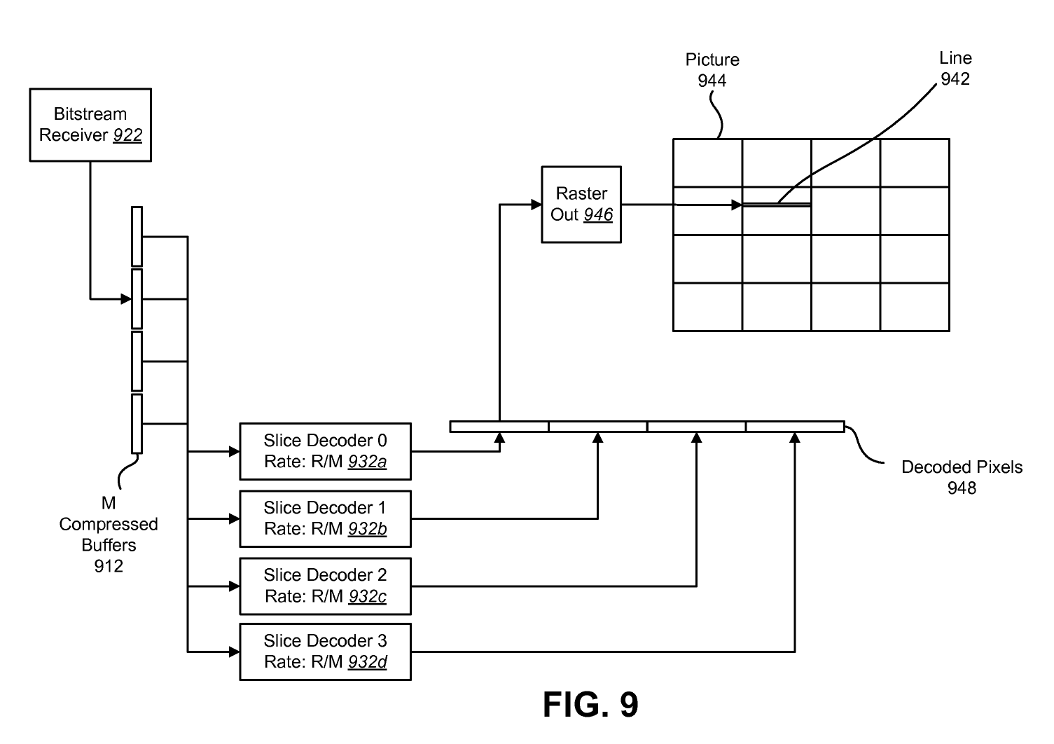

The decoder 232 may decode compressed data (e.g., slice M compressed 240b) from the compressed frame buffer 212. The decoder 232 may then write the pixel data 238 to the display panel 236. The slice 240 structure may permit slices 240 to be decoded in parallel. Parallel processing of slices 240 is especially useful for processing slices 240 in a line. Parallel processing of slices 240 is discussed in additional detail below in relation to FIG. 9.

The decoder 232 may need to access both the start and end positions of slices 240 in the compressed frame buffer 212 in order to decode the slices 240. Thus, the decoder 232 may read the compressed slice location list 230 to access necessary information. The display geometry 234 may determine where pixels should be written to the display panel 236. If parallel slice 240 decoding and raster scan writing are used for writing to a display panel 236, the pixel output of individual parallel decoders 232 may be interleaved.

The slice mapper 224 may write data to the same buffer that the decoder 232 is reading from. Without restrictions, the data being read by the decoder 232 could be overwritten by the slice mapper 224 as new data arrives. To avoid these collisions, a schedule of available times to access the compressed frame buffer 212 (read or write) may be enforced. It may be assumed that the decoder 232 begins decoding a frame from the compressed frame buffer 212 at an offset from the beginning of the frame time. The decoder 232 may operate on slices 240 in raster scan at a uniform rate until the end of the frame. Before the decoder 232 can access data for slice N 240, the encoder 218 must have first transmitted slice N 240 to the display module 204. The schedule of times for the encoder 218 to transmit data to the decoder 232 within a time frame may be limited by this constraint.

For regional updates, a limited number of full slices 240 of compressed data are sent from the host 228 to the display module 204. This is different from eDP 1.4, where selected regional updates are scan line based. The X position of selected regional updates may be any multiple of 16. Each regional update may include information describing the location of a slice 240 (e.g., the slice 240 number in a raster scan), information allowing the slice mapper 224 to determine the size of the slice 240 and information indicating where the slice 240 data should be placed in the compressed frame buffer 212. A regional update may include one or more slices 240. If a regional update includes multiple slices 240, the regional update may also include information describing location bits within the regional update for each slice 240 (e.g., signal slice 240 size, markers).

Regional updates may not be allowed at arbitrary times within a time frame (to prevent collisions between the slice mapper 224 and the decoder 232). This is similar to the constraint mentioned above, where the decoder 232 is assumed to operate at a uniform rate following the start of a frame. The transmission of a regional update may be restricted, such that the regional update is available before the decoder 232 access slices 240 corresponding to the regional update.

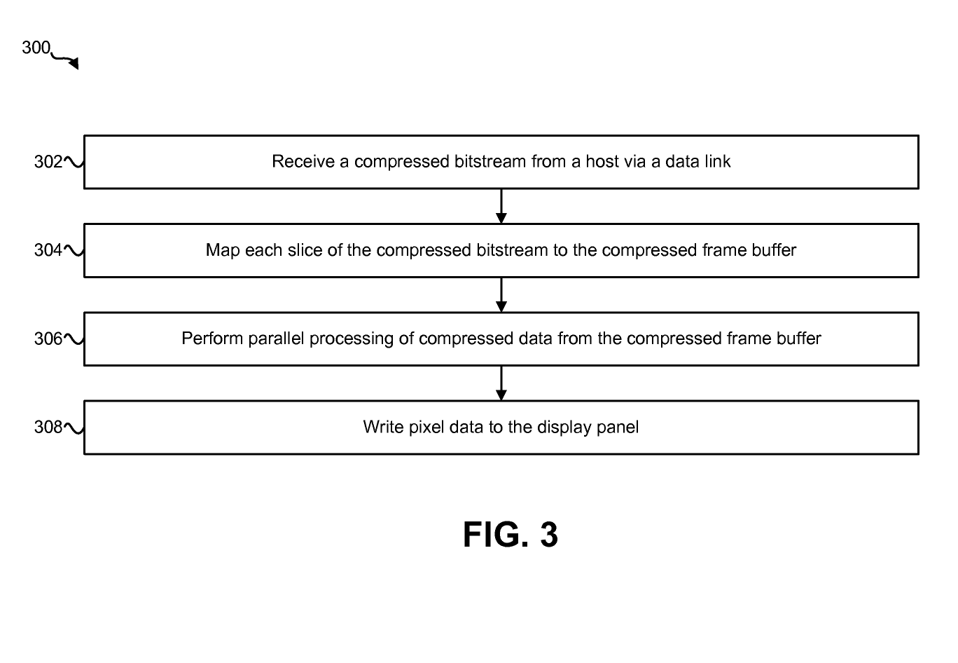

FIG. 3 is a flow diagram of a method 300 for display stream compression (DSC). The method 300 may be performed by an electronic device 102. The electronic device 102 may include a display stream compression (DSC) decoder 110. The electronic device 102 may receive 302 a compressed bitstream 239 from a host 228 via a data link. The electronic device 102 may map 304 each slice 240 of the compressed bitstream 239 to the compressed frame buffer 212. If the compressed bitstream 239 includes a regional update, the slice mapper 224 may replace the slices 240 in the compressed frame buffer 212 with their respective updates in the regional update. The electronic device 102 may perform 306 parallel processing of compressed data from the compressed frame buffer 212. As discussed above, restrictions may be placed on the slice mapper 224 and the decoder 232 to prevent collisions between reading the compressed frame buffer 212 and writing to the compressed frame buffer 212. The electronic device 102 may write 308 pixel data 238 to the display panel 236. For example, the decoder 232 may decode compressed data from the compressed frame buffer 212 and use this decoded data to display pixels 238 on the display panel 236.

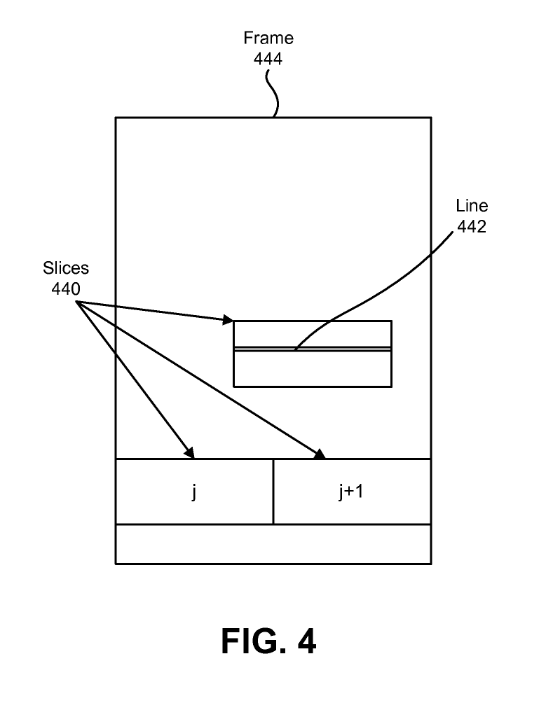

FIG. 4 is a block diagram illustrating a frame 444 that includes multiple slices 440. A frame 444 may also be referred to as a picture. Each frame 444 may be decomposed geometrically into rectangular sets of pixels for coding called slices 440. Each slice 440 is independently decodable. In display stream compression (DSC), all slices 440 typically have the same spatial size. Slices 440 may be numbered in the raster scan order. For a frame 444, HF refers to the height of the frame 444 in pixels and WF refers to the width of the frame 444 in pixels. For a slice 440, HS refers to the height of a slice 440 in pixels and WS refers to the width of a slice 440 in pixels. The height of a frame 444 in slices is defined as N=HF/HS, which is the number of slices 440 high. The width of a frame 444 in slices is defined as M=WF/WS, which is the number of slices 440 wide. In some configurations, the frame 444 may need to be padded to divide evenly for slices 440 wide and slices 440 high. A line 442 of a slice 440 is also illustrated. A line 442 may include one row of pixels within a slice 440.

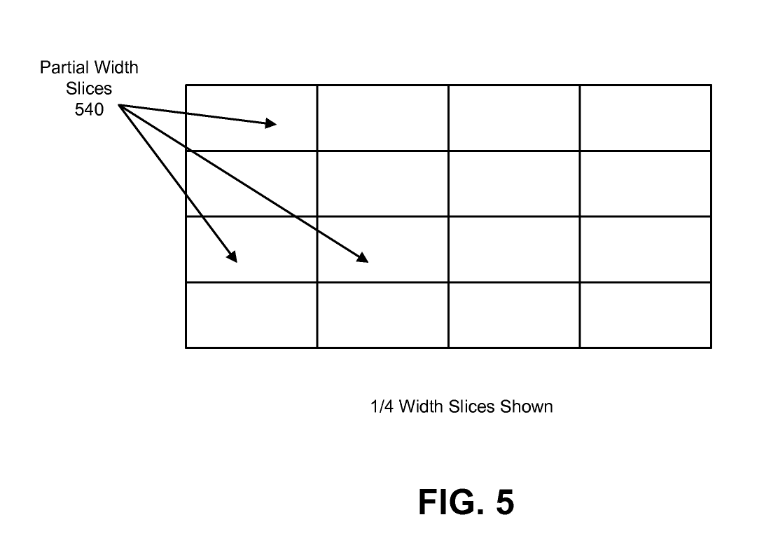

FIG. 5 is a block diagram illustrating partial width slices 540. Partial width slices 540 refer to the division of the picture into slices 540 with widths that are a fraction of the full picture width (M>1). As shown, M=4, resulting in ¼ width slices 540. The use of partial width slices 540 allows for partial slice processing (lower rate of each processor) and finer granularity for regional updates. However, for partial width slices 540, the slice structure must be fixed for regional updates. Furthermore, the small size of partial width slices 540 impacts coding efficiency (suggesting an HS of at least 8 lines 442). The parallelism is limited by the picture width in slices (M). Also, a slice to raster scan conversion should be avoided. Other issues with partial width slices 540 include the arrival order of slices, the interleaving of slice data, the relative delay of slice data and avoiding collisions in data access for regional updates.

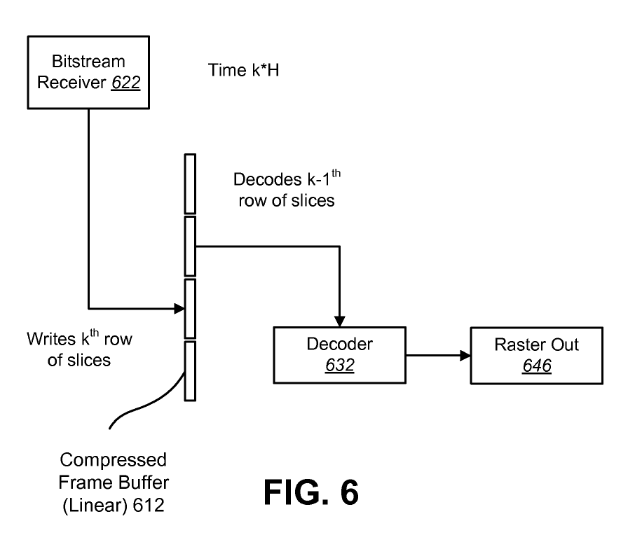

FIG. 6 is a block diagram illustrating a selective update decoder for use in the present systems and methods. Different hypothetical reference decoder (HRD) models may model the requirements on the delivery of bits to a decoder 232 for different applications. An HRD model may provide the means for ensuring that the delivery constraints are met. The HRD defines a buffer capacity and procedures for adding and removing bits from the HRD. The constraint for the HRD is that the HRD must not overflow or underflow. For example, merely requiring a large transport buffer is inappropriate. There are three HRD models: serial HRD, parallel decoding HRD and selective update HRD. The serial HRD is appropriate for typical single threaded decoding applications and full picture width slices. The serial HRD is used for high throughput applications.

The parallel decoding HRD is appropriate for parallel decoding of partial width slices 540 for increased throughput. The parallel decoding HRD reverts to the serial HRD when slices are equal to full width. A selective update HRD is appropriate for mobile devices using a compressed frame buffer 112.

In the proposed parallel HRD model, M refers to the number of threads, R is the bit rate, S is the size of the individual HRD buffers and D is the initial decoding delay. Each frame 444 is composed of slices 440 with width W/M, which form M columns of slices 440. Each column may be referred to as a thread. Each thread may have multiple slices 440 in height. The pixel time is denoted by P.

A parallel set of M HRDs may operate with relative delay and constant rates. There are M HRD models (one per thread). Each HRD buffer has equal size S and is initialized empty at the start of each frame 444. The operating rate is a constant input rate equal to the bits per pixel (bpp) link rate R/M for the HRD buffer of each thread. The initial decoding delay is specified as a number of pixels times

$$d + i \frac{W}{M}$$

for the ith HRD model. The arrival of bits in the ith HRD is delayed by

$$i \frac{R}{M}$$

bits relative to the arrival of bits in the 0^{th} HRD. After an initial delay, the bits arrive at each HRD at a uniform rate of R/M bits per pixel time P.

Parallel operation occurs on all threads. The removal schedule begins by removing bits from the ith HRD after the specified initial delay. Coded bits are removed from the ith HRD representing a group of pixels in the ith thread at each group time (P*M*number of pixels per group). The removal continues to remove bits corresponding to each group of pixels. When M=1, the parallel HRD model reverts to the serial HRD model. Each thread has an HRD which operates in parallel but is suitably delayed. The parallel HRD model enables an efficient parallel implementation but does not mandate a parallel implementation. The limits on the compressed bitrate variation may be used to design serial slice decoders as well.

For an application using selective updates, a frame buffer already exists. The requirements on the bitstream and the arrival schedule are reduced as compared to other HRD models. The slice geometry may be fixed (but can be selected from the options the decoder 232 presents). In addition, the size of a compressed slice 240 is fixed (i.e., bpp* pixels in a slice). The slice 240 data arrival may be constrained to allow decoding pipelined one row of slices 240 behind the transmission.

For the selective update HRD model shown, the slice 240 height H and width W are specified. The compressed frame buffer 112 is initially empty and the first frame 444 must include data for all slices 440 of the picture. During each frame 444, compressed data corresponding to a slice 440 in rows n*H through (n+1)*H can only be written to the HRD during line times n*H through (n+1)*H. The transport layer is responsible for ensuring this, either through appropriate buffering of received data or transport timing limitations. Slices 440 may be selectively skipped while obeying this constraint. Compressed data corresponding to slices 440 in rows m*H through (m+1)*H are read from the HRD at time (m+1)*H. The bits are not removed and are available for decoding subsequent frames 444 until overwritten.

In addition to delivering data according to the appropriate HRD model, the transport layer may convey additional information such as slice geometry, slice location information, and various flags. The slice geometry may specify the fixed spatial decomposition of each frame 444 into slices 440. The slices 440 may be numbered in raster scan order. The slice height/width should be consistent with low level compression size requirements (the slice 440 must include full code unit blocks). The frame 444 may be padded to an integer number of slices 440 high and wide. It may also be required that all slices 440 have the same size.

The slice geometry, slice size and picture resolution may be signaled to a decoder 232 external to the code stream or encoded in the code stream and extracted by the slice mapper 224. Slice geometry is typically fixed but could be changing. A change in slice geometry may be followed by a frame 444 that includes all slices 240 for the frame 444 in the new geometry (i.e., limited regional updates are not allowed when slice geometry changes). Each slice 440 that is received needs to be routed to an appropriate location/HRD model.

The transport layer may convey a flag indicating if the current frame 444 can be used for future partial update applications (i.e., the current frame 444 must be saved for the future). In some applications, this flag is required to be zero. But for mobile applications, this flag may be 1, which indicates data will be saved for future frames 444, or 0, which indicates that the data will not be needed and the memory may be powered down. The transport layer may also convey a flag that indicates all slices 440 are in the current frame 444. If all slices 440 are in the frame, slices 440 can be routed based on the order of arrival. If all slices 440 are not in a frame, each slice 440 can be routed based on slice identifier.

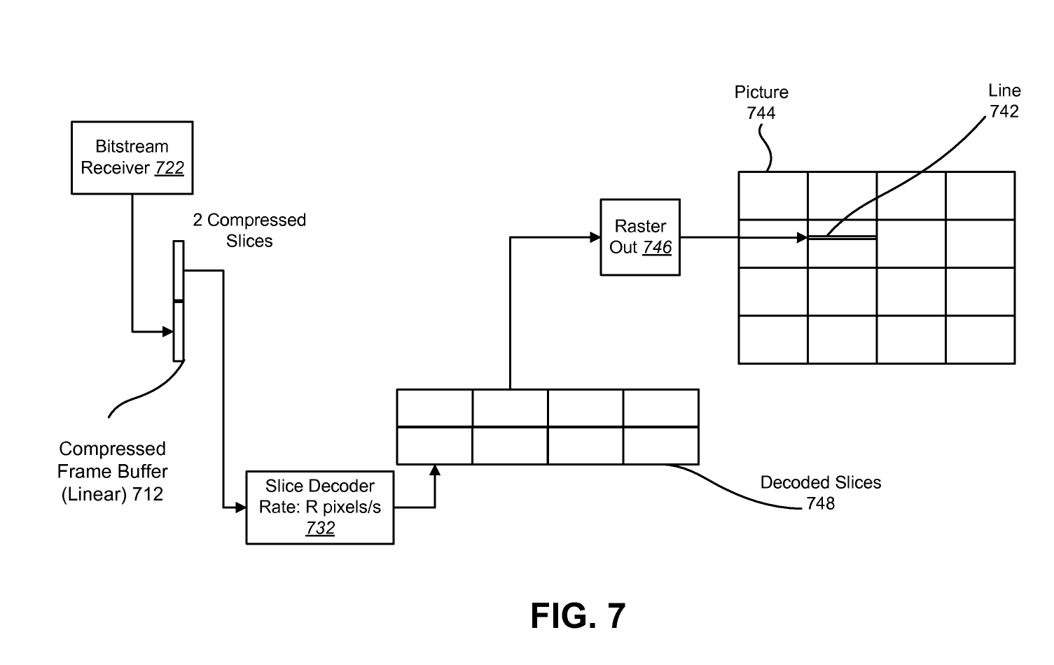

FIG. 7 is a block diagram illustrating serial slice decoding. For the serial slice decoding illustrated, the picture 744 width in slices 440 is M=4. Slices 440 from the compressed bitstream 239 are received by the receiver 722 and then placed into the compressed frame buffer 712 by the slice mapper 224. The slice decoder 732 may decode the slices 440 serially as they arrive. The slice decoder 732 may decode slices 440 at a rate of R pixels per second. The slice to raster order buffer includes two rows of uncompressed slices 748 that are then sent to the display in raster order (via raster out 746) and placed in the designated line 742 of the specific slice 440. One problem with serial slice decoding is the need of a significant buffer for slice to raster conversion.

A serial HRD has a buffer size of S bits, which is equal to the rate buffer size S. The bits per pixel rate is equal to the bpp rate R of the DSC encoder that the serial HRD is modeled on. The initial decode delay may be specified as part of the DSC configuration in units of pixel times. The input schedule may specify that bits start to arrive at an arbitrary time. Bits may arrive at the specified bits per pixel time rate. Bits may begin to be removed from the buffer after specified initial decode delay pixel times. Then, a specified number of bits per group may be removed at each group time. The group time is the pixel time multiplied by the number of pixels per group. The bits per group may have a fractional component. If so, the integer component of the value may be removed and the residual fraction may be added to the value to be removed at the next group. Bits may continue to be removed until the last group of the slice is decoded.

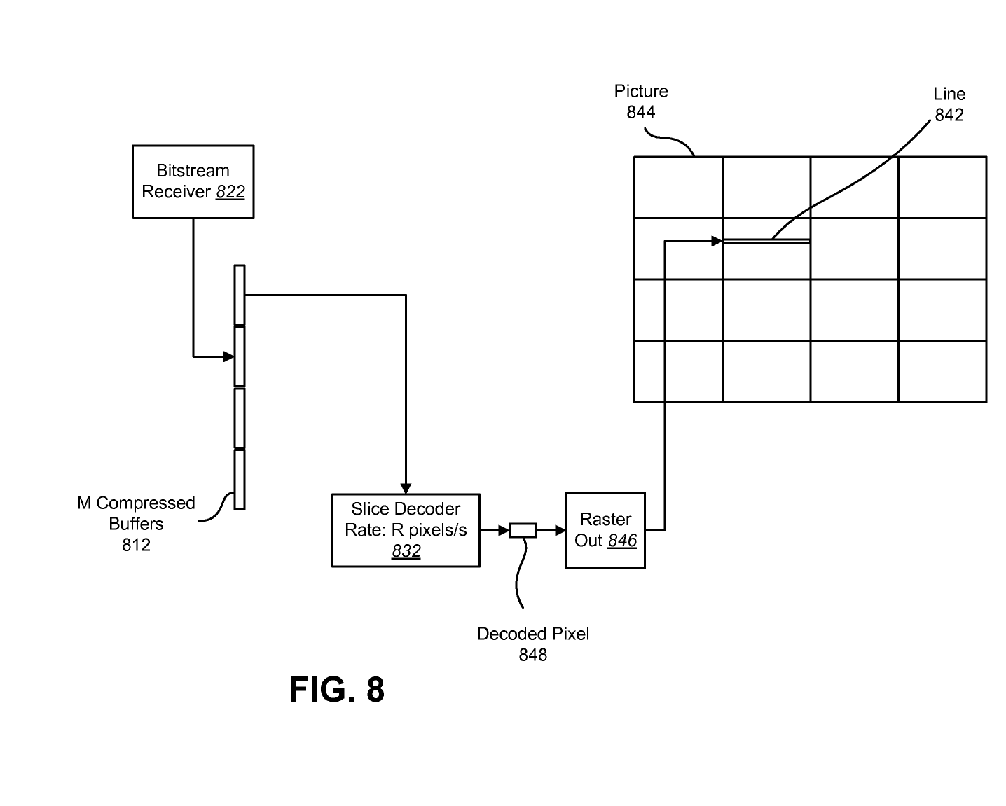

FIG. 8 is a block diagram illustrating round robin slice decoding. For the round robin slice decoding illustrated, the picture 844 width in slices is M=4. The compressed slices 440 are received via the compressed bitstream 239 by the receiver 822 and placed into M compressed buffers 812. The decoder 832 may reconstruct lines 842 of slices 440 by decoding pixels at the display rate R. Slices 440 in a row may be processed round robin in a time multiplex decoding of a single line of pixels from each slice 440. The decoded pixels 848 are then sent to the display in raster order (via raster out 846). With round robin slice decoding, a minimal buffer may be needed for uncompressed pixels with an appropriate delay of raster out and decoding.

The round robin slice decoding may decode lines 842 of pixels from all slices 440 in a row via time multiplexing to avoid significant raster buffering needs of the output. If the slices 440 are multiplexed per slice row time, the data for a row may not fit in a row time (likely for the first row of each slice 440). The decoder 832 must wait until data from the second row time has begun to arrive before beginning to decode the first line, to avoid stalling. This may increase the buffering needs. If finer levels of multiplexing are used (such as per byte or per bit), the buffering at the transport layer is minimal but each slice 440 needs a rate buffer equal to M*HRD size for slices 440 of width W/M, resulting in a total rate buffer that is approximately equal to that of a full frame. Individual slices 440 may be delayed by 1/M of a line time relative to the previous slice 440.

FIG. 9 is a block diagram illustrating parallel slice decoding within a row. For the parallel slice decoding illustrated, the picture 944 width in slices 440 is M=4. The compressed slices 440 are received via a compressed bitstream 239 by the receiver 922 and placed into M compressed frame buffers 912. M decoders 932a-d (each with a rate of R/M) decode pixels from the M compressed frame buffers 912 at the display rate

$$R = \frac{M \cdot R}{M} .$$

The decoded pixels 948 are then sent to the display in raster order (referred to as raster out 946). Parallel slice decoding may require a single line buffer that is

$$1 - \frac{R}{M}$$

of a line 942. The decoder 932 and raster out 946 are phased appropriately for a single line buffer.

Each slice 440 that is decoded in parallel may be delayed so that a single line raster buffer is sufficient. The individual slice decoders 932 may be staggered to reduce the reconstruction buffer. The decoder i+1 may be delayed 1/M line times relative to the decoder i. There may be M independent rate buffers. Data may be added to the buffer using various methods such as slice line time multiplexed or bit/byte multiplexed. The data may be removed from each rate buffer by a decoder 932 running at a reduced rate of W/M pixels per line time. The rate buffer capacity of the ith decoder is the size of the individual rate buffer. The relative delay to other decoders of (i−1)/M line times may increase the buffering needs. The total buffering is approximately the rate buffer of the picture without slices plus the buffer of

$$0 / M + 1 / M … ( M - 1 ) / M = M \cdot \frac{M - 1}{2} \cdot \frac{1}{M} = \frac{M - 1}{2}$$

line times of compressed data.

Both round robin and parallel processing may reduce the slice to raster conversion buffer size requirement. The buffering of the input may be increased to assure data is available for the decoders 932. Interleaved or parallel decoding of slices 440 requires access to data from all slices 440 of a row before the first slice 440 is fully decoded. The relative delay of an individual column of slices 440 is that column i+1 is delayed by i/M. The design of buffers should be such that buffering is not merely moved to the compressed domain.

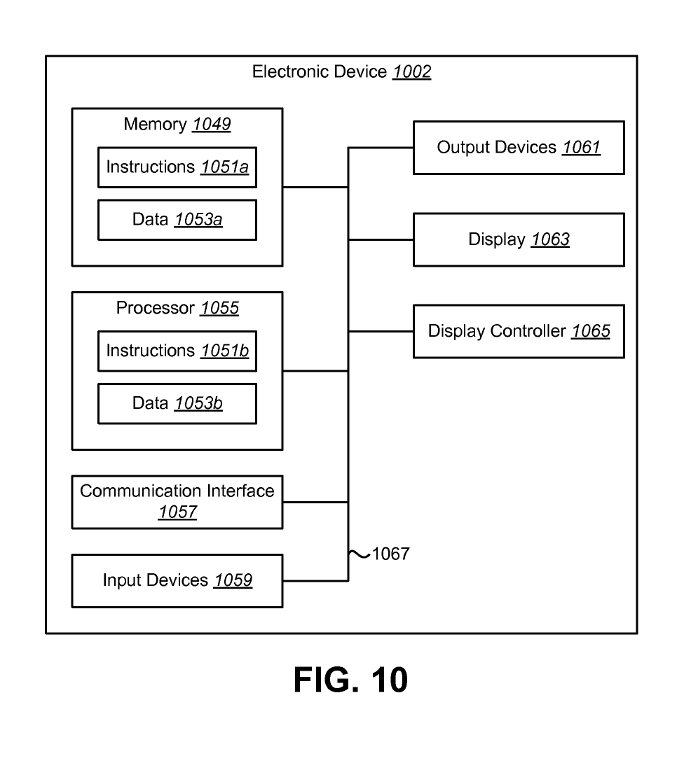

FIG. 10 illustrates various components that may be utilized in an electronic device 1002. The electronic device 1002 may be implemented as one or more of the electronic devices 102 described previously.

The electronic device 1002 includes a processor 1055 that controls operation of the electronic device 1002. The processor 1055 may also be referred to as a CPU. Memory 1049, which may include both read-only memory (ROM), random access memory (RAM) or any type of device that may store information, provides instructions 1051a (e.g., executable instructions) and data 1053a to the processor 1055. A portion of the memory 1049 may also include non-volatile random access memory (NVRAM). The memory 1049 may be in electronic communication with the processor 1055.

Instructions 1051b and data 1053b may also reside in the processor 1055. Instructions 1051b and/or data 1053b loaded into the processor 1055 may also include instructions 1051a and/or data 1053a from memory 1049 that were loaded for execution or processing by the processor 1055. The instructions 1051b may be executed by the processor 1055 to implement the systems and methods disclosed herein.

The electronic device 1002 may include one or more communication interfaces 1057 for communicating with other electronic devices. The communication interfaces 1057 may be based on wired communication technology, wireless communication technology, or both. Examples of communication interfaces 1057 include a serial port, a parallel port, a Universal Serial Bus (USB), an Ethernet adapter, an IEEE 1094 bus interface, a small computer system interface (SCSI) bus interface, an infrared (IR) communication port, a Bluetooth wireless communication adapter, a wireless transceiver in accordance with 3rd Generation Partnership Project (3GPP) specifications and so forth.

The electronic device 1002 may include one or more output devices 1061 and one or more input devices 1059. Examples of output devices 1061 include a speaker, printer, etc. One type of output device that may be included in an electronic device 1002 is a display device 1063. Display devices 1063 used with configurations disclosed herein may utilize any suitable image projection technology, such as a cathode ray tube (CRT), liquid crystal display (LCD), light-emitting diode (LED), gas plasma, electroluminescence or the like. A display controller 1065 may be provided for converting data stored in the memory 1049 into text, graphics, and/or moving images (as appropriate) shown on the display 1063. Examples of input devices 1059 include a keyboard, mouse, microphone, remote control device, button, joystick, trackball, touchpad, touchscreen, lightpen, etc.

The various components of the electronic device 1002 are coupled together by a bus system 1067, which may include a power bus, a control signal bus and a status signal bus, in addition to a data bus. However, for the sake of clarity, the various buses are illustrated in FIG. 10 as the bus system 1067. The electronic device 1002 illustrated in FIG. 10 is a functional block diagram rather than a listing of specific components.

The term “computer-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

It should be noted that one or more of the methods described herein may be implemented in and/or performed using hardware. For example, one or more of the methods or approaches described herein may be implemented in and/or realized using a chipset, an application-specific integrated circuit (ASIC), a large-scale integrated circuit (LSI) or integrated circuit, etc.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for video decoding, comprising:
receiving a compressed bitstream from a host via a data link;
mapping each slice of the compressed bitstream to a compressed frame buffer, wherein the compressed frame buffer supports selective overwriting for regional updates;
performing parallel processing of the compressed data in the compressed frame buffer; and
writing pixel data to a display panel.

2. The method of claim 1, wherein slice data is interleaved for transmission.

3. The method of claim 2, wherein slice data is provided to each decoder without buffering compressed data.

4. The method of claim 1, wherein the transmission of compressed data uses scheduling to avoid collisions between mapping slices to the compressed frame buffer and decoding slices from the compressed frame buffer.

5. The method of claim 4, wherein a decoder begins decoding a frame from the compressed frame buffer after an offset from the beginning of a frame time.

6. The method of claim 5, wherein the decoder operates on slices in raster scan at a uniform rate until the end of the frame.

7. The method of claim 1, wherein the method is performed by a mobile device.

8. The method of claim 5, wherein the method is performed by a display stream compression decoder on the mobile device.

9. The method of claim 1, wherein the compressed frame buffer is linear.

10. The method of claim 1, wherein a compressed slice location list is maintained for the compressed frame buffer.

11. The method of claim 10, wherein the compressed slice location list comprises a start time for each slice, an end time for each slice and a location of the slice within the compressed frame buffer.

12. The method of claim 1, wherein regional updates are implemented when a limited number of full slices of compressed data are received.

13. The method of claim 1, wherein regional updates comprise the location of a slice, a size of the slice and where the slice is located in the compressed frame buffer.

14. The method of claim 1, wherein the compressed frame buffer comprises reserved space for each slice based on slice geometry and a maximum size of each slice.

15. The method of claim 1, wherein content and transmission of the compressed bitstream are constrained by multiple hypothetical reference decoders (HRDs), wherein the arrival of bits in an ith HRD are delayed by
$$i \frac{R}{M}$$
bits relative to the arrival of bits in a 0^{th} HRD, and wherein R is a bit rate and M is a number of HRDs.

16. The method of claim 15, wherein bits arrive at an HRD at a uniform rate of R/M bits per pixel time P.

17. An electronic device, comprising:
a compressed buffer, wherein the compressed buffer supports selective overwriting for regional updates;
a slice mapper that maps a compressed bitstream to the compressed buffer;
one or more decoders that perform parallel processing of compressed data from the compressed buffer; and
a display panel that displays decoded data.

18. The electronic device of claim 17, wherein slice data is interleaved during transmission.

19. The electronic device of claim 18, wherein slice data is provided to each decoder without buffering compressed data.

20. The electronic device of claim 17, wherein the transmission of compressed data uses scheduling to avoid collisions between mapping slices to the compressed frame buffer and decoding slices from the compressed frame buffer.

21. The electronic device of claim 20, wherein each decoder begins decoding a frame from the compressed frame buffer after an offset from the beginning of a frame time.

22. The electronic device of claim 21, wherein the one or more decoders operate on slices in raster scan at a uniform rate until the end of the frame.

23. The electronic device of claim 17, wherein the electronic device is a mobile device.

24. The electronic device of claim 23, wherein the mobile device comprises a display stream compression decoder.

25. The electronic device of claim 17, wherein the compressed frame buffer is linear.

26. The electronic device of claim 17, wherein a compressed slice location list is maintained for the compressed frame buffer.

27. The electronic device of claim 26, wherein the compressed slice location list comprises a start time for each slice, an end time for each slice and a location of the slice within the compressed frame buffer.

28. The electronic device of claim 17, wherein regional updates are implemented when a limited number of full slices of compressed data are received.

29. The electronic device of claim 17, wherein regional updates comprise the location of a slice, a size of the slice and where the slice is located in the compressed frame buffer.

30. The electronic device of claim 17, wherein the compressed frame buffer comprises reserved space for each slice based on slice geometry and a maximum size of each slice.

31. The electronic device of claim 17, wherein content and transmission of the compressed bitstream are constrained by multiple hypothetical reference decoders (HRDs), wherein the arrival of bits in an ith HRD are delayed by
$$i \frac{R}{M}$$
bits relative to the arrival of bits in a 0^{th} HRD, and wherein R is a bit rate and M is a number of HRDs.

32. The electronic device of claim 31, wherein bits arrive at an HRD at a uniform rate of R/M bits per pixel time P.
